(19) United States
(12) Patent Application Publication
(10) Pub. No.: US 2014/0259721 A1
(43) Pub. Date: Sep. 18, 2014

(54) BIODEGRADABLE POLYMER NON-WOVEN FIELD BOOT DRYER INSERT WITH ABSORBENCY AND ANTIMICROBIAL CHEMISTRY

(71) Applicant: Biovation, LLC, Boothbay, ME (US)

(72) Inventors: Kerem Durdag, Scarborough, ME (US); Brian Pendleton, II, Newcastle, ME (US); Robert Hamlyn, Newcastle, ME (US); Valerie Gunn, Cape Neddick, ME (US)

(73) Assignee: Biovation, LLC, Boothbay, ME (US)

(21) Appl. No.: 14/206,412

(22) Filed: Mar. 12, 2014

Related U.S. Application Data
(60) Provisional application No. 61/779,011, filed on Mar. 13, 2013.

(51) Int. Cl. F26B 9/00

(52) U.S. Cl. CPC F26B 9/00
USPC 34/95

(57) ABSTRACT

Disclosed are boot (and other footwear) dryer insert materials that are to be used to dry out boots without the use of electric or mechanical power. Said boot insert dryer materials utilize a low bioburden, biodegradable and/or compostable moisture absorbing nonwoven structure and one or more antimicrobial and/or antifungal agents that minimize odor by mitigating the spread of odor causing pathogens. The drying process includes the ability of the outer surface of the boot dryer to allow the ingress of moisture absorbed from the boot while at the same time preventing captured moisture to escape back into the boot. Fluid absorbing or superabsorbent, capabilities may be incorporated in the devices of the present invention to control excess fluids. Also disclosed are methods of manufacture of the boot dryer inserts of the present invention.

### FIELD OF INVENTION

The invention relates to active dryer and moisture absorbing product whereby a low bioburden biodegradable and/or compostable absorbent nonwoven medium which does not support bacterial and fungal growth is employed in conjunction with at least one antimicrobial agent such as silver-based and/or silver ion-based active ingredients in the absorbent media or other packaging material. The insert drying material of the present invention functions to dry out boots in the field without the usage of electrical or mechanical power and mitigate odor causing microbes within the insert environment. Active ingredients that are part of the insert dryer packaging of the present invention can function in the condensed phase and the biodegradable nonwoven pad incorporated in a package can function as a carrier and/or a release vehicle for one or more antimicrobial and/or antifungal chemicals or other actives for other field drying applications.

### BACKGROUND OF THE INVENTION

The combat fighter in operational war zones traverses terrain that is not only wet but also has to execute mission objectives in wet weather. In doing so, combat boots get wet and soggy. Currently there is no effective way of drying them with the exception of rotating boot pairs, which, depending on the amount of moisture retained is usually not feasible. This leads to feet that can get blisters or infections resulting in discomfort for the fighter, reducing mobility and increasing potential injury. The invention has resulted in a product that will dry a pair of soaking wet combat boots within 6 hrs while meeting key requirements.

Similar need is also present in the hunting/fishing/hiking market and the workplace protective footwear market wherein consumers are in need of drying out boots when they are in the field conducting outdoor activities or working and there is no presence of electrical and mechanical power.

Key requirements for the invention that have been met, are:
1. Boot drying and containment system cannot need electrical power.
2. Product needs to be small, lightweight and portable and contain antimicrobial protection.
3. Product needs to have multi-use capability (ability to use more than once).
4. Product needs to have durability and strength to survive usage and harsh conditions.
5. Product needs to be cost-effective.
6. Product, as much as possible, should leave a very minimal environmental impact.

### 1. Description of Related Art

In any kind of drying product for footwear, an absorbent feature needs to be used for a variety of reasons that allows the product to be used multiple times. Typically, a superabsorbent polymer, or SAP, is employed in granular or fiber form along with a nonwoven pad comprised of spunbond or meltblown synthetic fibers or paper pulp fibers, to absorb fluid and/or moisture from surfaces that are in touch with the drying product. The product also has to dry surfaces that may not be necessarily in touch given the various shapes and geometric features of the boot or other items. The insert dryer typically will employ a film-based top and bottom layer with perforations that allow the fluid to reach the nonwoven absorbent layer and have necessary robustness and rigidity to survive the period of use on a repeated basis.

### SUMMARY OF THE INVENTION

This invention relates to absorbent, biodegradable dryer inserts suitable for use in drying wet footwear (e.g., boots, shoes, etc.), hats gloves and other garments. In this regard, the dryer insert of the present invention is not limited to any particular size or shape.

The prior art does not teach the insert of the present invention. For example, U.S. Pat. No. 8,069,587, assigned to 3M, describes a polylactic acid (PLA) biopolymer based footwear sole or footbed; there is no teaching of non-woven insert construction for boot drying. U.S. Pat. No. 7,985,452, assigned to Cerex, describes a silicone coated PLA fabric for purposes of being inserted in shoes; however, there is no teaching of non-woven insert construction for boot drying. U.S. Pat. No. 7,485,588 assigned to Wang, describes a textile substrate that has PLA for water repellency and stain protection; there is no teaching of non-woven insert construction for boot drying. U.S. Pat. No. 7,169,720 assigned to Etchells et. al describes a three-dimensional fabric that has PLA with SAP for moisture management; however it only teaches for knitted fabric and there is no teaching of a insert product for drying boots.

The key unique differentiators of our invention are: A) The PLA construction included calendared and non-calendared non-woven material from the meltblown process. B) The mixing of the non-calendared PLA (scrap, small pieces, etc.) to the SAP, and for the SAP to adhere to the PLA without the use of adhesives (relying on the fibers of the PLA material to entrap and encapsulate the SAP). C) The actual function of actually absorbing all the moisture in the boot and from the outside fabric of the boot and dry it out, in multiple environmental conditions. D) The construction of the insert with the sealed edges to make it pliable and robust. E) The light weight of the finished product. F) The ability of the finished product to be used 5-10 times.

In one embodiment of the present invention, it is contemplated that superabsorbent polymer (SAP) chemistry is integrated into the PLA substrates by incorporating the SAP granules to the fibrous substrate and “calendaring” (thermal glazing). Since the SAP is a generally insoluble cross-linked polyacrylamide polymer in granular form that adsorbs water and other fluid, the SAP is secured between two layers of the PLA fibrous web. This is accomplished by a thermal calendaring process which creates a compressed laminate structure (not using any adhesive) with the needed mechanical integrity. The porosity of the PLA substrate can be controlled by managing the heat used to calendar the material, and by the usage of an engraving roll that can place apertures on the film. This approach will be deployed in the construction of the inner core of the dryer inserts of the present invention.

This invention utilizes, but is not limited to, antimicrobial action generated in situ upon contact of the pathogen with the antimicrobial agent. The in situ, contact-based action of the present invention can be controlled via reaction chemistry or a triggering event, such as contact with moisture, or it can be constantly released thereby providing antimicrobial and/or antifungal protection throughout the packaging life cycle. It is contemplated that the antimicrobial agent(s) is specifically integrated to the thermoplastic fibers and released when moisture (liquid or gaseous), humidity or free water content in the boot, for example, makes contact with the insert and insert fibers and/or during the biodegradation of the fibers.

The scope of this invention encompasses those aspects of dryer insert that destroy or prevent microbial growth in and on a product by the use of an antimicrobial agent. The antimicrobial agents of the present invention can function in the condensed phase, where condensed phase means a liquid or solid, or in a gaseous phase and said antimicrobial agents can be generated in situ via a chemical reaction, or used as-is, or released in a controlled fashion.

The invention also includes, but is not limited to, the antimicrobial chemistries described herein used in conjunction with biodegradable nonwoven fibers and non-biodegradable nonwoven fibers, the fibers having antimicrobial activity and/or very low bioburden. Such biodegradable and low bioburden fibers include those based on poly(lactic) acid, also known as polylactide, and its various L, D and meso configurations, including mixed L, D, and meso compositions, their various crystallinities, molecular weights, and various co-polymers. In this work poly(lactic) acid it is understood to be synonymous with poly(lactide) and both terms encompass all the optically active variations of the polymer.

The current invention advances the art of insert dryer products on three fronts. In an embodiment, the invention contemplates absorbent media which is specifically integrated to a biodegradable thermoplastic polymer non-woven layer concurrently with the creation of a unique apertured biodegradable thermoplastic polymer film. The nature, construction and advantages of said absorbent media, together with the biodegradable thermoplastic polymer, are unique and non-obvious. Second, the absorbent media is combined with silver and/or silver-based antimicrobial and/or antifungal chemistry in a specific fashion that allows for a long-lasting, robust and cost-effective antimicrobial action. Preferred embodiments of the antimicrobial and/or antifungal chemistry are novel in their own right, but the major advance is demonstrated in the concomitant use of both concepts: novel and non-obvious absorbent media architecture utilizing the biodegradable polymer with a surface to the insert dryer product being apertured (i.e., porous or having porosity or having perforations or “pinpricks”) and/or non-apertured (i.e., non-porous or essentially non-porous, not having perforations or “pin pricks”; allowing no more than a trivial amount of liquid and or gas to pass though the film) in combination with the novel and non-obvious silver and/or silver-based antimicrobial and/or antifungal chemistry. The apertures of the present invention can be created through the calendaring process or created by other means known to those of skill in the art at the time of the invention. Even without apertures, the film may still have limited porosity much as fabric may allow limited amounts of liquid or gas to traverse the material. Third and finally, the super-absorbent polymer is affixed to the biodegradable thermoplastic polymer non-woven fiber without the use of adhesives to yield an inner core of the product that has the necessary capability and capacity to absorb the moisture in the boot, for example, on a repeatable use basis, with the ability to go through multiple wet-dry cycles without losing performance.

All aspects of this invention, the construction of the product using biodegradable thermoplastic polymer, the absorbent media and details of odor control via controlled release silver and/or silver ion-based antimicrobial and/or antifungal chemistry should be understood in order to clearly delineate the advancement of the art.

The term “antimicrobial” and “antifungal” with respect to odor control is known in the art to include any composition and/or method to reduce or inhibit microbial growth (including bacteria and fungi) and, therefore, has wide breadth in the art. There are several commercial products such as AgION (manufactured by Sciessent, Wakefield, Mass.) which are incorporated into footwear and clothing items which purport to reduce the amount of odor generated due to physical activity and etc.

A preferred antimicrobial and antifungal agent is ionic silver, being released from a nonwoven pad made preferably from poly(lactic) acid fibers incorporating, in one aspect, absorbent media and superabsorbent media.

Examples of suitable silver and silver ion-based agents include, but are not limited to, silver halides, nitrates, nitrites, selenites, selenides, sulphites, sulphates, sulphadiazine, silver polysaccharides where such polysaccharides include simple sugars to polymeric and fibrous polysaccharides, silver zirconium complexes, forms including organic-silver complexes such as silver trapped in or by synthetic, natural or naturally-derived polymers, including cyclodextrins; all compounds, inorganic or organic, that contain silver as part of the structure, where such structures can exist as a gas, solid, or liquid, as intact salts, dissolved salts, dissociated species in protic or aprotic solvents and silver species which contain the molecular morphology or macroscopic properties of materials in contact with silver whereby such materials, either organic, inorganic, and/or of biological nature, are found in various morphologies, such as crystalline or amorphous forms, or optical activities, such as d, l or meso forms, or tacticities such as isotactic, atactic, or syndiotactic, or mixtures thereof of any of the above.

Silver ion-based agents include and are defined as, for example, compounds that contain silver as part of the structure that can be covalently bound, ionically bound, or bound by other mechanisms known as “charge-transfer” complexes, including clathrate compounds that involve silver or silver species as part of the structure. Silver ion-based agents also include silver or silver containing species that exist as a result of the process of sorption, either chemical or physical sorption, meaning absorption or adsorption, where the sorptive surface can be a molecule, polymer, organic or inorganic entity such as, but not limited to, synthetic oligomers or polymers (either thermoplastic or thermoforming), natural or naturally-derived polymers (either thermoplastic or thermoforming), biodegradable and non-biodegradable polymers (either thermoplastic or thermoforming), and inorganic or organic species whose surface area provides for some sorptive effect including, but not limited to, charcoal, zeolites of all chemical structures, silica, diatoms, and other high-surface area materials, also including silver or silver species in all its known valence states, either organically or inorganically bound, and includes organic or inorganic materials, either gas, liquid, or solid, where the silver or silver species can “exchange” or transfer by mechanisms such as, but not limited to, ion-exchange, diffusion, replacement, dissolution, and the like, including silver glass, silver zeolite, silver-acrlyic and nano-silver structures. Zeolite carrier based (the silver ions exchange with other positive ions (often sodium) from the moisture in the environment, effecting a release of silver “on demand” from the zeolite crystals) and glass based silver chemistries (soluble glass containing antimicrobial metal ions wherein with the presence of water or moisture, the glass will release the metal ions gradually to function as antimicrobial agents), are non-limiting examples of silver-ion-based agents suitable for use in the present invention.

Another preferred antimicrobial and antifungal agent is ionic copper, being released from a nonwoven pad made preferably from poly(lactic) acid fibers incorporating, in one aspect, absorbent media and superabsorbent media.

Examples of suitable copper and copper ion-based agents include, but are not limited to, copper halides, nitrates, nitrites, selenites, selenides, sulphites, sulphates, sulphadiazine, copper polysaccharides where such polysaccharides include simple sugars to polymeric and fibrous polysaccharides, copper zirconium complexes, forms including organic-copper complexes such as copper trapped in or by synthetic, natural or naturally-derived polymers, including cyclodextrins; all compounds, inorganic or organic, that contain copper as part of the structure, where such structures can exist as a gas, solid, or liquid, as intact salts, dissolved salts, dissociated species in protic or aprotic solvents and copper species which contain the molecular morphology or macroscopic properties of materials in contact with copper whereby such materials, either organic, inorganic, and/or of biological nature, are found in various morphologies, such as crystalline or amorphous forms, or optical activities, such as d, l or meso forms, or tacticities such as isotactic, atactic, or syndiotactic, or mixtures thereof of any of the above.

Copper ion-based agents include and are defined as, for example, compounds that contain copper as part of the structure that can be covalently bound, ionically bound, or bound by other mechanisms known as “charge-transfer” complexes, including clathrate compounds that involve copper or copper species as part of the structure. Copper ion-based agents also include copper or copper containing species that exist as a result of the process of sorption, either chemical or physical sorption, meaning absorption or adsorption, where the sorptive surface can be a molecule, polymer, organic or inorganic entity such as, but not limited to, synthetic oligomers or polymers (either thermoplastic or thermoforming), natural or naturally-derived polymers (either thermoplastic or thermoforming), biodegradable and non-biodegradable polymers (either thermoplastic or thermoforming), and inorganic or organic species whose surface area provides for some sorptive effect including, but not limited to, charcoal, zeolites of all chemical structures, silica, diatoms, and other high-surface area materials, also including copper or copper species in all its known valence states, either organically or inorganically bound, and includes organic or inorganic materials, either gas, liquid, or solid, where the copper or copper species can “exchange” or transfer by mechanisms such as, but not limited to, ion-exchange, diffusion, replacement, dissolution, and the like, including copper zeolite, and nano-copper structures. Zeolite carrier based (the copper ions exchange with other positive ions (often sodium) from the moisture in the environment, effecting a release of copper “on demand” from the zeolite crystals), are non-limiting examples of copper-ion-based agents suitable for use in the present invention.

Any combination of the above exemplary silver and copper and silver and copper ion-based agents is also contemplated for use in the insert dryer of the present invention.

In a preferred embodiment of the present invention, the antimicrobial and antifungal agents are incorporated into the actual fibers of the insert dryer product. In this embodiment, the agents are added to the polymer prior to the formation of the polymer into fibers. In this embodiment, the agents are released as the fibers breakdown and thereby provide antimicrobial and antifungal affects to in which the dryer insert is placed. In this embodiment, the antimicrobial and antifungal agents are released, at least in great part, as the fibers in the non-woven pad degrade in the package environment. In another embodiment, the antimicrobial and antifungal agents are interspersed between the fibers of the dryer insert. In this embodiment, the agents are added to the fiber composition after the polymer is formed into fibers. In this embodiment, the antimicrobial and antifungal agents are released, at least in part, as the fibers in the non-woven pad degrade in the package environment. In yet another embodiment the antimicrobial and antifungal agents are both incorporated into the actual fibers and interspersed between the fibers.

In other embodiments, non-silver and non-silver ion-based antimicrobial and antifungal agents are contemplated for use with the dryer inserts of the present invention. These non-silver and non-silver ion-based agents may be used in conjunction with the silver and silver ion-based agents of the present invention. One of ordinary skill in the art, based on the teachings of the present specification, can determine suitable combinations of agents depending on the fiber composition of the dryer insert, the size of the dryer insert, the size of footwear, etc. Suitable non-silver and non-silver ion-based agents are, but are not limited to, compounds containing zinc, copper, titanium, magnesium, quaternary ammonium, silane (alkyltrialkoxysilanes) quaternary ammonium cadmium, mercury, biguanides, amines, glucoprotamine, chitosan, trichlocarban, triclosan (diphenyl ether (bis-phenyl) derivative known as either 2,4,4′-trichloro-2′ hydroxy diphenyl ether or 5-chloro-2-(2,4-dichloro phenoxyl)phenol), aldehydes, halogens, isothiazones, peroxo compounds, n-halamines, cyclodextrines, nanoparticles of noble metals and metal oxides, chloroxynol, tributyltins, triphenyltins, fluconazole, nystatin, amphotericin B, chlorhexidine, alkylated polethylenimine, lactoferrin, tetracycline, gatifloxacin, sodium hypophosphite monohydrate, sodium hypochlorite, phenolic, glutaraldehyde, hypochlorite, ortho-phthalaldehyde, peracetic acid, chlorhexidine gluconate, hexachlorophene, alcohols, iodophores, acetic acid, citric acid, lactic acid, allyl isothiocyanate, alkylresorcinols, pyrimethanil, potassium sorbate, pectin, nisin, lauric arginate, cumin oil, oregano oil, pimento oil, tartaric acid, thyme oil, garlic oil (composed of sulfur compounds such as allicin, diallyl disulfide and dyallyl trisulfide), grapefruit seed extract, ascorbic acid, sorbic acid, calcium compounds, phytoalexins, methylparaben, sodium benzoate, linalool, methyl chavicol, lysozyme, ethylenediamine tetracetic acid, pediocin, sodium lactate, phytic acid, benzoic anhydride, carvacrol, eugenol, geraniol, terpineol, thymol, imazalil, lauric acid, palmitoleic acid, phenolic compounds, propionic acid, sorbic acid anhydride, propylparaben, sorbic acid harpin-protein, ipradion, 1-methylcyclopropene, polygalacturonase, benzoic acid, hexanal, 1-hexanol, 2-hexen-1-ol, 6-nonenal, 3-nonen-2-one, methyl salicylate, sodium bicarbonate and potassium dioxide.

Thus, in an embodiment of the present invention, the invention comprises an absorbent, biodegradable dryer insert, comprising: at least one layer (i.e., a core) of non-woven fibers comprising one or more biodegradable thermoplastic polymers incorporated to the superabsorbent polymer and one or more silver-based or silver ion-based antimicrobial agents; and at least one outer layer of non-woven fibers with the necessary mechanical properties of flexibility and robustness comprising one or more biodegradable thermoplastic polymers incorporated to one or more silver-based or silver ion-based antimicrobial agents. The silver-based or silver ion-based antimicrobial agents can be are incorporated into the non-woven fibers or interspersed between the non-woven fibers. The fibers of the dryer insert product are, in an embodiment, oriented to provide expansion due to the absorption of moisture and fluids and maintain paths for liquid-flow and air-flow, preferentially in a direction transverse or essentially traverse to an exterior surface. Further, the fibers of the present invention may be vertically lapped or spirally wound. “Vertically lapped” is defined herein as meaning that the ends of one set of fibers overlap vertically with the ends of another set of fibers, i.e., the fibers of the first set of fibers and the fibers of the second set of fibers are oriented substantially in the same direction and are overlapping to some degree. “Spirally wound” is defined herein as meaning that the fibers form substantially a helix.

In our current invention, although we can utilize synthetic fibers such as polypropylene and polyethylene, or paper such as recycled paper, we preferentially employ natural plant-based materials, such as natural polymers or naturally-derived meltblown nonwoven polymer fibers or filaments. One example is poly(lactic) acid (PLA), as defined above. The PLA is degradable and renewable, and has a low bioburden as opposed to, for example, recycled wood pulp. From an end-use standpoint and a processing and manufacturing standpoint, the low bioburden profile achieved with the nonwoven process precludes any heat drying that is required to destroy microbes present in a wood or tissue-based product; allowing a “cleaner” and safer system when compared to traditional alternatives such as wood pulp.

Another differentiating feature of PLA is that PLA is completely compostable, resorbable and safe in terms of cytotoxity, versus recycled pulp or synthetic fibers. One of the degradation products of poly(lactic) acid is lactic acid, which is produced in the human body.

Another feature differentiating the present invention from prior art technology is that the dryer insert actually physically dries out, for example, a boot in a given time frame as a function of the ambient environmental conditions. The construction of the product may use a multiplicity of methods. Our selection of PLA (or other suitable thermoplastic fibers) eliminates the need for glue via the ability of thermoplastic materials ability to thermal bond and seal. This feature allows for equivalent internal and perimeter bonding of the fibers compared to the current technique of “stitching,” ultrasonic bonding or adhesive bonding. Stitching is a process wherein the pulp fibers are mechanically forced via a calendar roll to interlock; in adhesive bonding glue is applied to one surface and adhered to the opposing side. In ultrasonic bonding, sound waves are utilized to fuse two surfaces together. The present invention of thermal bonding, ultrasonic bonding, stitching or adhesive bonding the poly(lactic) acid fibers provides the necessary mechanical strength. In many applications, a “four-side sealed” product is preferred as this prevents the absorbent contents from escaping. Current practice requires the interior core, be smaller than the overall dryer insert product to allow the upper and lower film layers direct contact for sealing. Additionally, the present invention can also have three edge seal with the utilization of “overlap” surfaces. With the biodegradable thermoplastic core structure of the present invention, the entire pad, outer film layers plus core, can be thermally, ultrasonically, stitch or adhesive bonded, thereby allowing a streamlined and lower cost manufacturing process and added design capabilities as the dryer insert can easily be fabricated in complex shapes to fit, for example, the inside of a shoe, boot or other footwear or garment.

In another feature differentiating the present invention from the prior art, as compared to the limited prior art wherein poly(lactic) acid is employed as a dryer insert, is that the PLA of the present invention can be specifically engineered to be fully degradable as well as function in a dual-use as a carrier or active component in an antimicrobial and/or antifungal release system.

Another feature differentiating the present invention from the prior art is that in the present invention the method of meltblowing the PLA fibers into continuous filaments is novel and non-obvious and imparts unique characteristics to the dryer insert of the present invention. The unique characteristics allow, for example, for the incorporation multiple layers of fibers and filaments that serve specific functions including, but not limited to, three-dimensional inserts, or molded or formed drier systems using pattern forming techniques. The multiple layering is also useful to provide specific absorbency without the need to perform separate lamination operations, as is typically done in the prior art. Separate lamination operations encompasses a sequence of discrete process steps wherein sheets and webs are created on separate forming stations or machines and then utilizing a bonding system, the individuals webs are thermally or adhesively or ultrasonically fused together.

In one embodiment of the present invention, the fibers form a non-woven core that forms the absorbent portion of the dryer. The core may be covered with a surface film as described and exemplified in detail below. The core, the core in combination with the film and/or the film may be present in multiplicities (i.e., pluralities)—in other words, there may be one or more layers of core and surface film in any order or combination as is necessary for suitable fluid absorption and retention (until the dryer is rejuvenated for reuse by being dried out), for flexibility and robustness and antimicrobial/antifungal action. The surface film may comprise, but is not limited to, a biodegradable thermoplastic polymer hydrophobic film is comprised from one or more of polylactic acid, polylactide, polyglycolide, poly-L-lactide, poly-DL-lactide or copolymers thereof.

In another embodiment of the present invention, the fibers of the core of the dryer insert are oriented to provide compression resistance and maintain paths for liquid-flow and air-flow. In one embodiment, the fibers are oriented in a direction substantially traverse to the exterior surface. In other words, when formed in to a non-woven sheet, the fibers run substantially parallel to the surface of the sheet.

As an example, the boot dryer insert of the present invention is capable of drying out boots in 6, 7, and up to 14 hours with the ability to be used 1, 2, 3, 4, 5, up to 10 times when liquid is absorbed by the boot dryer insert. The drying action can be without the rupturing of any surface film or the sealed edges of any surface film that envelopes or encases the non-woven core(s) of the dryer insert.

The dryer insert of the present invention is capable of holding up to 1.5, up to 2, up to 5, up to 10 times of the original weight of the dryer insert when liquid is absorbed by the dryer insert. The expansion can be without the rupturing of any surface film or the sealed edges of any surface film that envelopes the non-woven core(s) of the dryer insert.

In another embodiment of the present invention, the PLA fibers of the present invention can be used in combination with other fibers such as spunbond polypropylene or polyethylene, but the fibers used with the PLA fibers of the present invention are not limited to those two materials. For example, the PLA fiber or fibers can be employed as an outer surface of a multi-layer construction to provide a barrier against the friction rubbing of the product against the insider surfaces of the boot, for example, as it is inserted continuous times. Additionally, hydrophilic or hydrophobic layers in a single layer or multilayer construction are possible where either the PLA or the other polymer, or both, are treated with materials to render the nonwoven filaments hydrophilic or hydrophobic, depending on the end use and purpose. The hydrophilic and hydrophobic materials can be introduced in the fiber prior to extrusion via masterbatching or via a subsequent process such as coating, spraying or dipping. The introduction of hydrophilic and hydrophobic materials to the fibers is not limited to the techniques mentioned here but can be accomplished by any technique available to those of ordinary skill in the art.

PLA polymer is suitable at the 100% level in this application, however, with the inclusion of additives such as co-polymers, masterbatch additives and/or plasticizers, other additional advantages are observed. The term “additives,” as defined herein, are compounds that affect the manufacture and/or physical characteristic of the fibers and dryer inserts of the present invention (i.e., also referred to as processing agents). As an example, when polycaprolactone, a degradable polymer often used in medical implants, is incorporated at up to 50% of the blend with PLA it imparts flexibility and softness to counteract the brittle nature of the PLA. Other additives function as plasticizers, lubricants and processing aids in the fiber spinning process. Examples of such methods and suitable agents are known to those of ordinary skill in the art as is shown by and outlined in, for example, “Processing and Mechanical characterization of plasticized Poly(lactide acid) films for food packaging V. P. Martino, R. A. Ruseckaite, A. Jiménez, Proceeding of the 8th Polymers for Advanced Technologies International Symposium Budapest, Hungary, 13-16 Sep. 2005”, and “Poly(lactic acid): plasticization and properties of biodegradable multiphase systems Polymer, Volume 42, Issue 14, June 2001, Pages 6209-6219, O Martin, L Avérous”, and “European Patent EP19990300874, assigned to KABUSHIKI KAISHA KOBE SEIKO SHO also known as Kobe Steel Ltd. (3-18, Wakinohama-cho 1 chome, Chuo-ku, Kobe, 651-0072, JP)” and “Study of Effects of Processing Aids on Properties of Poly(lactic acid)/Soy Protein Blends, Bo Liu, Long Jiang and Jinwen Zhang, Journal of Polymers and the Environment Volume 19, Number 1, 239-247.”

Suitable examples of plasticizers, lubricants and processing aids are CP-L01 from Polyvel (Hammonton, N.J.) which is a PLA plasticizer specifically targeted to improving the toughness, impact and processing capabilities of PLA. Another product by Polyvel is CT-L01, a lubricant, which improves slip characteristics while retaining other properties; it decreases PLA's high coefficient of friction and therefore reduces or eliminates adhesion between other film or metal surfaces during production. Additionally, Polyvel CT-L03 is a processing aid which raises intrinsic viscosity of PLA providing increased molecular weight and improved melt strength. Finally, Polyvel HD-L02 is a rubberizer which allows for the increase in the expansion capabilities of PLA. Many other similar products are present in the commercial polymer additive and modifier marketplace.

In our invention the PLA can be thermally glazed (also known as “calendaring”). This is a distinct advantage over conventional materials that have been used for footwear applications. Heat with calendaring and even exposure to blasts of hot air can render the nonwoven filaments with a smooth film-like surface, yet still have porosity to fluids and moisture. With regard to the present invention, the calendaring process and the effect it has on the surface of the non-woven thermoplastic core of the dryer insert of the present invention may be considered to be a surface film. Porosity can be controlled by controlling the heat used to calendar the material, and by the usage of an engraving roll that can place apertures on the film. Glazing can be an overall surface treatment or a variable/zone application. For purposes of visual comparison only, and not for comparison to mechanical or end-use properties, the smooth glazed PLA fibrous surface resembles in looks only the commercial product Tyvek®. The purpose of the fiber glazing (calendaring) process is to eliminate the need for a separate film, and it provides a unique and advantageous method to control fluid flow in the boot or other footwear or garment with a minimum of lamination and processing effort while increasing the utility of the dryer insert. Non-limiting examples of the range of porosity that can be achieved by the calendaring process of the present invention are shown in Table 3, below. One of ordinary skill in the art would be able, with guidance from the teachings of the present invention, to extrapolate times and temperatures necessary for a desired porosity.

In a further embodiment of the present invention, the outer layer can be constructed eliminating the need for glues and adhesive bonding by utilizing the calendaring process and, at the same time provide, if warranted, perforations (apertures) that allow the fluids to flow into the absorbent core. The current art, in reference to a moisture management material in footwear, may have perforations in the protective layer that is in contact with foot. Such layers are typically knit materials or polyethylene, but they are not limited to either knit materials or polyethylene. The present invention also provides for a construction whereby a protective film, typically polyethylene or polypropylene, but not limited to those materials, and in present invention successfully done with polylactic acid (e.g., comprised from one or more of polylactic acid, polylactide, polyglycolide, poly-L-lactide, poly-DL-lactide or copolymers thereof), can be thermally bonded to the PLA absorbent core, if desired. The present invention utilizes thermal bonding which can bond similar and dissimilar materials including but not limited to film to film, film to fiber and fiber to fiber, generally employing thermoplastic materials including, but not limited to, thermoplastic materials of natural, naturally-derived or synthetic origin, both organic and inorganic in nature, as exemplified elsewhere in this specification.

In a further embodiment of the present invention, construction of the dryer insert can incorporate superabsorbent technology. The usage of the one or more superabsorbent agents allows the dryer insert to absorb the free fluid (e.g., water, sweat, etc.) that is frequently present in footwear applications (hunting, combat operations, industrial work such as oil rig operators, etc.) to provide, for example, a boot owner with a method to wear dry boots in the field where electrical and/or mechanical power is not available. Superabsorbents are generally insoluble crosslinked polyacrylamide polymers in granular form that absorb water and fluid, but the field of superabsorbent polymers is not limited to polyacrylamide chemistry, as is known by those of ordinary skill in the art. Superabsorbents, abbreviated SAP, provide an economical means to increase fluid-holding capacity. U.S. Pat. Nos. 7,732,036 and 7,799,361 (both of which are incorporated herein by reference in their entirety) teach the use of SAP technology in a dryer insert. Further, SAPs are available commercially. However, conventional use of SAP's do not preclude the escape of the particles from the absorbent dryer insert area into the footwear thereby allowing the SAP to possibly come in contact with, for example, the boot and consequently the foot.

In a further embodiment of the present invention, the SAP particles are secured to either the nonwoven fibers in the core of the dryer insert product or in the previously described films that contact the footwear or garment surface. First, for example, SAP's can be delivered to the fibrous web and to positioned between layers. They can be held in place mechanically by the fibrous web. Second, for example, any granular SAP's used in the present invention can be secured between two layers of the fibrous web and thermal calendared so as to create a compressed and mechanically bonded pad. Third, for example, any granular SAP's used in the present invention can be secured with an aqueous polyacrylic acid solution polymer and an appropriate crosslinker. Such a polyacrylic acid solution polymer is described in U.S. Pat. No. 7,135,135 (incorporated herein by reference in its entirety), assigned to H.B. Fuller Licensing and Financing, Inc., under the trade name FULATEX PD8081H. The crosslinking agent can be an aqueous zirconium reagent or any other appropriate crosslinker described in the patent or known in the art. U.S. Pat. No. 7,135,135 further describes a spray-able material that is superabsorbent. The present invention may employ the FULATEX PD8081H as a means to secure granular superabsorbent powder dispersed in the nonwoven absorbent web, where the nonwoven preferentially comprises totally or partially a fibrous poly(lactic) acid filament. The present invention does not preclude the use of FULATEX PD8081H on other natural, naturally-derived or synthetic nonwoven materials or with other granular materials, especially, but not limited to, various antimicrobial and/or antifungal agents. Further, with regard to the present invention, FULATEX PD8081H can in itself be and function as part of a multi-component active ingredient release system (i.e., a controlled release system such as that taught by the present invention).

In a further embodiment of the present invention, antibacterial agents can be added into the polymer that is then meltspun into fibers. In other words, the antimicrobial agents are incorporated into the polymer fibers of the present invention. This provides protection and encapsulation of the antimicrobial agents and provides controlled release of the agents as the polymers of the present invention degrade as they are designed. Antibacterial, antimicrobial and antifungal agents can also be incorporated into the dryer insert materials of the present invention in a variety of ways.

In an embodiment of the present invention, the antimicrobial action is incorporated into the polymer fiber structure of the present invention. There is no antimicrobial action imparted on (e.g., applied to) the to the, for example, boot surface or the foot itself. The presence of the antimicrobial agent(s) in the non-woven material prevents the dryer insert product from discoloring due to speckling caused by, for example, of the presence of mold. It also prohibits the spread of pathogens on the dryer insert product itself, which would acquire moisture during use (and hence, a possible location for pathogen propagation).

One novel and unique improvement of the present invention over the related prior art is that the present invention integrates the antimicrobial compound as a masterbatch directly into the thermoplasitc (e.g., polylactic acid) fibers as part of the meltblown fiber manufacturing process with specifically tuned process variables (as exemplified below) which results in the non-woven material used in the dryer insert product. Additionally, an improvement of the present invention is to be able to specifically calendar (as a function of speed, pressure and temperature) the polylactic acid polymer non-woven material with the antimicrobial formulation in order to allow it to function as a dryer insert.

One novel and unique improvement of the present invention over the related prior art is the construction of the pad from polylactic acid in a novel fashion that allows multiple layers of non-woven polylactic acid fibers to manufactured with multiple layers of superabsorbent captured in those layers without the use of adhesive, by utilizing the calendaring process directly in the meltblown processing line for the multiple layers. This allows for manufacturing flexibility and optimization while ensuring the robustness of the non-woven material layer(s) in order for it to function as a dryer insert.

One novel and unique improvement of the present invention over the related prior art is the construction of the pad from polylactic acid in a novel fashion that allows multiple layers of non-woven polylactic acid fibers to manufactured with multiple layers of superabsorbent captured in those layers without the use of adhesive, by mixing, grinding and blending the superabsorbent granules with strips of the polylactic acid meltblown fiber. This allows for manufacturing flexibility and optimization while ensuring the robustness of the non-woven material layer(s) in order for it to function as a dryer insert product.

Another improvement of the present invention over the related prior art is the construction of the pad from the polylactic acid with the integrated superabsorbent polymer in a unique fashion using the calendaring of the PLA non-woven materials such that it allows the pad to absorb up to 5 grams of water per 3″×5″ dryer insert, or up to 10 grams of water per 8″×12″ dryer insert, or up to approximately 0.5 gms per square inch (i.e., up to 5 times its dry weight) without rupturing and the PLA layers adequately stretching and keeping dryer insert integrity intact. Thus, the dryer insert of the present invention has the unique property of absorbing and retaining high volumes of liquid thereby drying the boots, for example, out in the field without the user of electrical and/or mechanical power. This novel advancement makes the functionality of the dryer insert to act as a field drying product possible.

### DESCRIPTION OF THE FIGURES

FIG. 1 shows a schematic diagram of a generic meltblown fiber manufacturing line.

FIG. 2 shows a schematic of a non-woven calendaring process.

FIG. 3 shows the relationship between fiber diameter and throughput rates.

FIG. 4 shows a close-up photograph of meltblown fibers.

FIG. 5 shows a photograph of oriented meltblown fibers.

FIG. 6 shows a close-up photograph of meltblown fibers.

FIG. 7 shows a close-up photograph of meltblown fibers.

FIG. 8 shows a cross-sectional view of the dryer (e.g., boot dryer) insert pouch.

FIGS. 9A & B show a non-woven PLA mat folded and sealed on two sides.

FIG. 10A-E shows an overview of the process of constructing a dryer insert covering from non-woven PLA.

FIG. 11 shows a photograph of “SAP fill material.”

FIG. 12 shows the filing of the dryer insert with the SAP and PLA mixture.

FIG. 13 shows an embodiment of a completely sealed dryer insert product.

FIG. 14 shows a cross-sectional view of the dryer insert with the SAP fill material.

FIG. 15 shows cut SMS material in a 10′ (feet)×12″ (inch) sheet.

FIG. 16 shows the first step in construction of the outer pouch.

FIG. 17 shows the heat sealing of the outer pouch.

FIGS. 18A & B show the dryer insert and outer pouch before and after assembly.

FIGS. 19A & B shows the sealing of the remaining side of the outer pouch and an embodiment of the final dryer insert product.

FIG. 20 shows a cross-sectional view of the boot dryer insert with SAP fill material in an inner pouch which is then place in the outer pouch.

FIG. 21A-C shows the inner pouch in the outer pouch and final assembly.

FIG. 22A-C show schematic representations of the dryer insert positioned in a boot.

FIG. 23 shows a photograph of the dryer insert of the present invention in a boot.

FIG. 24 shows another representation of the dryer insert of the present invention.

### DETAILED DESCRIPTION OF THE INVENTION

As used herein, the term “polymer” refers to thermoplastic, natural, naturally-derived, synthetic, biopolymers and oligomeric species thereof. As used herein, the term “oligomer” refers to a low molecular weight polymer of two or more repeating monomeric repeating units. Polymers specifically include, but are not limited to, PolyLactic Acid (PLA); PolyCaproLactone (PCL) and PolyHydroxyAlkanoate (PHA) alone or in blends/alloys or as copolymers.

Wherein the disclosed methods are given, these are only exemplary and one of skill in the art will understand that, based on the teachings provided herein, modifications of these procedures are within the metes and bounds of the present invention.

NatureWorks (Minnetonka, Minn.) produces several grades of PLA in pellet form that can be melt processed into film or fibers and are useful in this invention. Many grades are useful however grade 6202D as a high melt-point version with the optional use of grade 6251D as a low-melt binder fiber have proven to process well in the present invention. Perstorp (Toledo, Ohio) produces PCL and, although several grades are suitable for use in the present invention, grade Capa 6800 processes well. Mirel PHA from Metabolix (Cambridge, Mass.) is also compatible with the present invention.

When processing PLA, to maintain maximum chain length, it is important to dry the polymer is a commercial desiccant dryer such as a Conair (Cranberry Township, Pa.) “W” series machine to a moisture level below 200 ppm. This is critical as PLA polymer is extremely hydroscopic and will acquire moisture from the air rapidly. This moisture hydrolytically degrades the polymer chains resulting in a reduced viscosity and thus product strength. If moisture levels are too high, the additional problem of steam generation and uncontrolled pressures within the extrusion system are observed.

For exemplification, for production, a Davis-Standard (Pawcatuck, Conn.) single screw 30:1 2.5″ extruder (or equivalent) with melt temperatures of 350 to 425° F. and pressures of 500 to 2000 psi are achieved at the outlet. The polymer passes thru filtration to remove particulate debris and enters a pressure control zone achieved via a positive displacement Zenith (Monroe, N.C.) gear pump. Molten pressurized polymer is delivered to a melt-spinning die produced by BIAX (Greenville, Wis.). Several arrangements of nozzles, diameters, and total nozzle count can be varied to suit the polymer and final production needs. A typical spinning die contains 4000-8000 nozzles/meter of width with an internal diameter of 0.25-0.50 mm may be utilized efficiently. It must be noted that melt spinning dies produced by other suppliers such as Hills (W. Melbourne, Fla.) or Reifenhauser (Danvers, Mass.) may be used.

Heated and high velocity air is introduced into the die and both polymer and air steams are released in close proximity allowing the air to attenuate the polymer streams as they exit the die. Air temperatures of about 230-290° C. with pressures at the die at about 0.6 to about 4.0 atmospheres may be used. Following extrusion and attenuation, cool and/or moist air may be used to quench the fibers rapidly. At this point, liquids or mists can be applied to coat the surface. Surfactants, antimicrobials, or adhesives can be beneficially adhered to the fibers.

The fibers may be collected on a single belt or drum or a multiple belt or drum collector. Air is drawn from below the belt(s) or drum(s) and fibers collect in a web or matt on the surface. There are many adjustments in the entire system, temperatures, pressures, quench conditions, extrusion air velocity, suction air velocity, etc. With these adjustment points, a matt that is, for example, stiff and thin or flexible and fluffy is possible. For this invention, a low-density structure with fine-diameter fibers is beneficial although one of skill in the art will realize that other densities and diameters are suitable for use in the present invention. The low density improves fluid acquisition and the small diameter maximizes surface area, which is important for the release of “actives” from the fibers.

Fiber diameters can range from approximately 1 to 30 microns (μm) however it is possible to produce nano or sub-micron fibers via increased hot air attenuation and/or low polymer throughputs. The cost of production increases as a result however the overall surface area of the fibers increases. Likewise, larger fibers are easily produced when attenuation air is reduced or eliminated and/or melt pressures are increased. A compromise of cost and performance is seen in, approximately, the 5-25 micron range. Within the large number of consecutive fibers being spun, it can be important to allow a range of diameters as this has been observed to increase the loft or thickness of the structure and this provides for improved shock absorbing and cushioning properties. Different diameters can be achieved by adjusting the internal nozzle diameters and/or air velocity at certain nozzles or by directing external cooling air toward certain fiber streams.

The invention described herein involves numerous embodiments around the production and use of biodegrable thermoplastic polymer fiber layers with super absorbent polymer (SAP) granules captured within the layers and fibers together with an antimicrobial, antifungal and biocidal agent in a dryer insert that also provides for a natural or naturally-derived material, such as a nonwoven fibrous pad, where the agent is designed to prohibit, mitigate, prevent or inhibit microbe growth or kill microbes on the dryer insert structure itself.

It is preferred to place “actives” in the polymer (as described and exemplified throughout the present specification) and, thus, in each fiber and/or interspersed between fibers. Traditionally, actives have been defined as chemical or physical agents that impart specific performance characteristics (as opposed to merely physical characteristics) to polymers. For example, it is current state of art to incorporate in to textile products actives using specialized pharmaceuticals and natural and botanical ingredients to provide odor control. In our invention, actives are defined, at least in part, as antimicrobial ingredients which mitigate and control the propagation of pathogen in and on the polymer fibers and in the dryer insert environment. A good overview of antimicrobial actives for textile application can be seen in “Recent Advances in Antimicrobial Treatments of Textiles, Yuan Gao and Robin Cranston, Textile Research Journal 2008; 78; 60” or the use of antimicrobial actives as agents in polymers in “U.S. Pat. No. 5,906,825, Polymers containing antimicrobial agents and methods for making and using same,” both of which are indicative of what is known by one of ordinary skill in the art are incorporated herein by reference.

However, many materials will not tolerate the heat and pressure of extrusion. For example, halogens (iodine, chlorine, bromine) and chlorides (PVC) can release corrosive gas that can rapidly attack the machinery and require expensive alloys for protection; however, silver does not present these problems. As an alternative to a polymer-additive, after the polymer fibers are formed, the poly(lactic) acid can be treated by coating, immersion, spraying, printing or any other technique capable of transferring an ingredient or ingredients onto the fibers. The purpose of such treatment could be to promote release of the antimicrobial agent and could include, but is not limited to, water, lactic acid, lactide, organic and inorganic acids and bases, and catalysts.

If the product does not require the application of any absorbent or superabsorbent (SAP) granules or other powder “actives,” the web can proceed into winding and die cutting to final size/shape.

If granules are utilized (SAP, for example) a powder spreader is positioned to introduce powder directly into the path of the molten fibers as they are collected above a vacuum source. This vacuum source is a part of a flat belt collector, a dual drum collector or 3-D pocket former for the formation of dimensional and discrete parts. More than one spinning head can be utilized to allow the granules to be positioned generally in the center of the structure. It has been found that several mechanical arrangements are possible and that very high performing structures are possible with a fiber-supported interconnecting structure with SAP. Up to 85% SAP by weight has been tested with the present invention. The SAP can be calendared into/onto the non-woven fiber cores of the present invention.

If granules are utilized (SAP, for example) a powder spreader is positioned to introduce powder directly onto the non-woven fiber material once it has been created. The non-woven fiber material can be cut, torn, split or shredded and collected in a container and the powder spreader can be positioned to deposit the granules onto the material. Once the granules have been deposited, the mixture can be mechanically mixed, agitated and blended using a variety of methods, including but not limited to industrial mixers and blenders. It has been found that several mechanical arrangements are possible and that very high performing SAP laden fibrous “pieces” are possible with a fiber-supported interconnecting structure with SAP.

The SAP laden fibrous pieces can be inserted into the dryer insert pouch with only two or three sides sealed, to comprise the core. Once the insertion is completed, the third or fourth edge can be sealed to yield a dryer insert product. The dryer insert product had the ability to dry out a completely soaked boot in about a 6 hour period. Thus, the present invention is suitable, for example, in drying footwear overnight for next day use.

The SAP laden fibrous pieces can also be inserted to a “sock” manufactured by non-woven meltblown materials or utilizing off-the-shelf SMS material, with all the edge sealed to comprise the core. Once the core is complete, it can be inserted into the dryer insert pouch with only two or three side sealed. Once the insertion is completed, the third or fourth edge can be sealed to yield a dryer insert product. Such a construction completely mitigated against the “spill out” of the core in the event of a catastrophic failure (tear, puncture, split, etc.) of the outer layer.

### EXEMPLIFICATION

### Example 1

### Creation of the PLA Non-Woven Dryer Insert Outer Layer

Grade 6202D PLA polymer pellets from NatureWorks (Minnetonka, Minn.) were utilized from a fresh unopened bag and introduced into the mouth of a 2.5″ 30:1 40-hp extruder and exposed to mechanical shear and heat ranging from approximately 325 to 425° F. as it travels through the system. Filtration followed by a gear pump pushed the molten polymer thru a heated transfer line into a BIAX meltblown system at approximately 800 to 2000 psi. Compressed air was heated to approximately 475-525° F. and introduced into the die at approximately 10-18 psi and used to attenuate the PLA fibers thru nozzles with an internal diameter of about 0.012 inches. A filtered water mist quench was produced using a high-pressure piston pump and a fluid-misting system. This quench was operated at approximately 500-1800 psi and the mist impinges the fibers as they exit the die zone and serves to cool them. An air quench system introduced cool outside air to the fibers before they were deposited on a flat belt with a vacuum source below. The speed of this belt determined the weight of the web. For most boot dryer applications a boot dryer insert from about 10 to about 200 grams per square meter (gsm) is required. The vacuum level additionally served to compress the web, or allow it to remain fluffy and at a low density. Calendar or thermal point bonding served to strengthen the dryer insert and impart strength. Once the dryer insert was calendared it was directed to a windup station for final packaging and assembly. Refer to FIG. 1 for a schematic view of the process.

Following collection on the belt, the web was wound into a roll and delivered to a roll wind up station. In some embodiments, depending on the requirements of the application, this web can be unwound from the station, and passed through a series of rollers and lamination stations, to get conjoined with an equivalent web, to yield a dryer insert with increased compressibility and mechanical characteristics. Such a web, either one layer or more layers, was cut to size.

As a reference for mechanical properties, the tensile strength of one 33 gsm PLA layer was measured to be 0.765 in/lbs using a Twing-Albert (West Berlin, N.J.) Tensile Tester using ASTM D5035 protocols (as is known to those of ordinary skill in the art). A 66 gsm PLA layer was measured to be 3.884 in/lbs using a Twing-Albert Tensile Tester using ASTM D5035 protocols.

### Example 2

### Calendering of Outer PLA Non-Woven Fiber Layer

In order to impart different properties to the outer non-woven PLA layer of the dryer insert calendaring can be utilized. We used a BF Perkins (division of Standex Engraving, LLC, Sandston, Va.) Calendar Station which contained two heated rolls and two hydraulic rams. Each heated roll was filled with high temperature oil, which was heated by a separate machine. A hot oil machine controlled the temperature and the flow of oil through each zone of the Calendar Station. The temperature can range from 110 to 550° F. The hot oil was circulated at 30 psi through 2 inch iron pipes into a rotary valve for each zone.

The Calendar Station was opened and closed by a control station which also regulated the amount of pressure used to move the hydraulic rams. This pressure can range from 1 psi to 3,000 psi and maintained the amount of force with which the Drive Roll was supported. A variable spacer between the Sunday Roll (also called an Engraved Roll) and the Drive Roll maintained the distance of one roll to the other. The spacer allowed for the thickness of the PLA and the hydraulic rams maintain that distance. See, FIG. 2 for a schematic representation of the process. Non-limiting specifications are given below. One of ordinary skill in the art will be able to modify these specifications based on the guidance provided by this specification.
i. Top roll, labeled Sunday Roll, was an engraved roll; 7⅜″ diameter by 20″ length.
ii. Bottom Roll, labeled Drive Roll, was a smooth roll; 10″ diameter by 19½″ length.
iii. The temperature was variable on product density and speed of the process line. The speed can range, for example, from 1 to 200 FPM (feet per minute) with a temperature of 175 to 350° F.
iv. The distance between the rolls was a variable controlling product thickness which can range from 0.5 to 0.001 inch.

### Example 3

### Creation of PLA Non-Woven Outer Layer with Antimicrobial Agents

The PLA non-woven outer layer was manufactured with an antimicrobial agent. The antimicrobial agent utilized was silver. The silver in the PLA acted as a biocidal agent and slowed the growth of bacteria and fungi on the pad itself and hereby reducing odor and mold growth.

1BSK-1 and 1BSK-2 were sample identifiers for manufactured PLA non-woven sheets. 1BSK-1 is 120 gsm melt spun PLA integrated with a formulation of silver and copper Zeolite grade AC-10D from AgION (Wakefield, Mass.) coupled with silver glass grade WPA from Marubeni/Ishizuka (Santa Clara, Calif.). 1BSK-2 is 120 gsm melt spun PLA integrated with a formulation of silver and copper Zeolite grade AC-10D from AgION coupled with silver glass grade WPA from Marubeni/Ishizuka and calendered. See, Table 1, below.

TABLE 1

| | Line | | | Sample | Tensile | Permea- |
|---|---|---|---|---|---|---|
| | Speed | Temp | Calendar | Thickness | Strength | tion |
| | (ft/min) | (F.) | Gap (in) | (in) | (in/lbs) | (g/hm2) |
| 1BSK-1; | 20 | n/a | n/a | 0.022 | 7.067 | |
| 120 gsm un- | | | | | | |
| calendared | | | | | | |
| 1BSK-2; | 20 | 220 | 0.015 | 0.018 | >11 | 76.022 |
| 120 gsm | | | | | | |
| calendared | | | | | | |

Different variations of PLA calendared film, inclusive of apertures, can be manufactured with different mechanical properties based on the teachings of the present specification. For example, PLA Film 1 was calendared 33 gsm PLA integrated with a formulation of silver and copper Zeolite grade AC-10D from AgION coupled with silver glass grade WPA from Marubeni/Ishizuka at 240° F., 40 fpm, at 0.001 inch gap under 900 psi. PLA Film 2 was calendared 66 gsm melt spun PLA integrated with a formulation of silver and copper Zeolite grade AC-10D from AgION coupled with silver glass grade WPA from Marubeni/Ishizuka at 280° F., at 10 fpm, at 0.005 inch gap, under 1,000 psi. Corresponding test data is shown below in Table 2.

TABLE 2
If the corresponding PLA Film 1 and PLA Film 2 were uncalendared,
the data is as follows (which clearly shows the effects of calendaring):
g/hm² = grams per hour times meter squared

| | | | Permeation |
|---|---|---|---|
| | Tensile Strength | Apparent | (ASTM E96) |
| | (ASTM D5030) | elongation (%) | (g/hm²) |
| PLA Film 1 | 2.999 in/lbs | 6.884% | 80.2337 |
| PLA Film 2 | 5.579 in/lbs | 5.064% | 67.7960 |
| PLA Film 1 - | 0.765 in/lbs | 5.886% | 67.4622 |
| uncalendared | | | |
| PLA Film 2 - | 3.784 in/lbs | 3.814% | 64.9974 |
| uncalendared | | | |

As a reference for mechanical properties, the determination of permeation is conducted according to ASTM E96/E96M-10, Water Vapor Transmission of Materials Test methodology using permeation cups by BYK-Gardner (Columbia, Md.) and weigh scale by Mettler Toledo (Columbus, Ohio).

The size of the apertures for PLA Film 1 and PLA Film 2 were measured to be 0.022 inches in diameter. The apertures can be of a given shape (circular, diamond, etc.) as determined by the design of the engraved roll (Sunday roll).

Additional permeation characteristics can be designed with various constructions as exemplified in the Table 3 below.

TABLE 3

| | Permeation ((ASTM |
|---|---|
| Construction | E96) (g/hm²) |
| Two layers of 50 gsm uncalendared PLA integrated with a formulation of | 156.7750 |
| silver and copper Zeolite grade AC-10D from AgION coupled with silver | |
| glass grade WPA from Marubeni/Ishizuka with 50 gsm of SAP in | |
| between the said PLA layers | |
| Two layers of 50 gsm uncalendared PLA integrated with a formulation of | 171.6458 |
| silver and copper Zeolite grade AC-10D from AgION coupled with silver | |
| glass grade WPA from Marubeni/Ishizuka without any SAP in between | |
| the said PLA insert layers | |
| Two layers of 66 gsm calendared PLA integrated with a formulation of | 145.0521 |
| silver and copper Zeolite grade AC-10D from AgION coupled with silver | |
| glass grade WPA from Marubeni/Ishizuka with two layers of 50 gsm | |
| calendared PLA insert which has 50 gsm of SAP in between the PLA | |
| layers | |
| Two layers of 66 gsm calendared PLA integrated with a formulation of | 148.0729 |
| silver and copper Zeolite grade AC-10D from AgION coupled with silver | |
| glass grade WPA from Marubeni/Ishizuka with two layers of 50 gsm | |
| calendared PLA insert which has no SAP in between the PLA insert | |
| layers | |
| Two layers of 66 gsm calendared PLA integrated with a formulation of | 155.8896 |
| silver and copper Zeolite grade AC-10D from AgION coupled with silver | |
| glass grade WPA from Marubeni/Ishizuka with two layers of 33 gsm | |
| calendared PLA insert which has 2 gsm of SAP in between the PLA | |
| layers | |
| Two layers of 66 gsm calendared PLA integrated with a formulation of | 157.4042 |
| silver and copper Zeolite grade AC-10D from AgION coupled with silver | |
| glass grade WPA from Marubeni/Ishizuka with two layers of 33 gsm | |
| calendared PLA insert which has no SAP in between the PLA layers | |

### Example 4

### Active Structure with Polymer Additives for Lubrication for PLA

This example is similar to Example 1, above, however a polymer additive or masterbatch in dry form was added into the PLA to impart lubricity. When added to the PLA at a 3.0% level higher volumetric throughput rate was observed (higher density; i.e., gsm attainment) while maintaining the same operating pressures, indicating a lower resistance to pumping. The higher volumetric throughput rate was observed by the increased rpm on the melt-pump and extruder motor. The melt additive used was CP-L01 from Polyvel Inc. (Hammonton, N.J.), a multipurpose plasticizer additive. When CT-L01 was substituted, also from Polyvel, at 3% level, lubricant or processing aid for “slip,” the same throughput rate at lower extruder and meltpump speeds was observed. When HD-L02 was substituted, also from Polyvel, at 10% level, to see the effects on processing.

The data below (Table 4) shows the change in density (gsm) for different runs of PLA integrated with a formulation of silver and copper Zeolite grade AC-10D from AgION coupled with silver glass grade WPA from Marubeni/Ishizuka with different process settings and with different levels of additives.

TABLE 4

| | Density, extruder speed (rpm) and |
|---|---|
| | meltpump speed (rpm) |
| PLA non-woven material | 63gsm, Extruder RPM 12%, |
| | Melt Pump RPM 19% |
| 97% PLA with 3% CP-L01 material | 65gsm, Extruder RPM 13.5%, |
| | Melt Pump RPM 21% |
| 97% PLA with 3% CT-L01 material | 55gsm, Extruder RPM 11%, |
| | Melt Pump RPM 18% |
| 94% PLA with 3% CP-L01 and | 63gsm, Extruder RPM 11%, |
| 3% CT-L01 material | Melt Pump RPM 18% |
| 60% PLA with 40% HD-L02 | 180gsm, Extruder RPM 14%, |
| | Melt Pump RPM 20% |

Similar results (not shown) as above were obtained with polypropylene based on the guidance provided by the present specification for those of ordinary skill in the art.

### Example 5

### Active Structure with Topical Hydrophilic Treatment Added for PLA

This is similar to Example 1 except the hydrophilic additive was in liquid form mixed into the water quench system and sprayed directly on the fibers while hot. Many surfactants are candidates; however polyethylene glycol (PEG) 200-900 mw is preferred. The concentration used was based on the weight of the fibers strayed and a range of 0.05% to 2.0% has proved beneficial in promoting rapid fiber wet-out. Additionally, the resultant fibrous web demonstrates a more rapid fluid acquisition speed was observed. This enhanced hydrophilicity was advantageous when an absorbent article with rapid fluid uptake was desired. The liquid additive used was Lurol PP-2213 from Goulston Technologies, Inc. (Monroe, N.C.), which is marketed as a single-use surface hydrophilic agent into the hygiene and diaper industry. The results were dramatic as almost immediate wet-out occurs. A similar product also useful in the present invention, Lurol PS-9725-NAD from Goulston, provides immediate wet-out also and is marketed as offering semi-durable performance. Another product, Triton X-100 (Dow Chemical, Midland, Mich.) was also tried successfully.

Similar results as above were obtained with polypropylene based on the guidance provided by the present specification for those of ordinary skill in the art.

A 33 gsm polypropylene material was created with 3% TMP12713, a modifier manufactured by Techmere (Clinton, Tenn.).

### Example 6

### Active Structure with Ionic Silver and Ionic Copper Controlled-Release Antimicrobial Feature

This example is similar to Example 1 except a custom masterbatch containing a slow-release silver ion compound was incorporated to provide broad antimicrobial and antifungal performance. Several silver-releasing materials have been evaluated including, silver and copper Zeolite grade AC-10D from AgION, silver glass grade WPA from Marubeni/Ishizuka, silver zirconium, Alphasan from Milliken (Spartanburg, S.C.). In each case, a 20-30% loading in a carrier polymer was prepared and used to uniformly deliver the silver additive into the mix. One preferred silver and copper agent was the silver zeolite grade AC-10D from AgION which also contained copper elements as an anti-fungal agent. Another preferred silver was the WPA silver glass powder from Marubeni/Ishizuka. Particle size of less-than 5 microns was specified with an average of 2-3 microns to preclude spinneret nozzle clogging. The final concentration of silver in the meltblown fibers was dependent on the quantity of masterbatch used. In trials, up to 20% masterbatch has been processed to demonstrate an extreme loading, up to 5% silver by weight. For the performance required of the dryer insert, we have found 20 to 1000 ppm loading of actual silver, as a portion of the silver-based additive use with the pad, to be effective. In boot dryer applications silver was highly effective as its slow release and long-term bacterial control properties match the end-use requirements. The silver was placed in a masterbatch with PLA, or an olefin carrier. For PLA fibers, the PLA carrier is preferred to maintain the degradability performance.

To determine the efficacy of antimicrobial formulation, samples of a PLA non-woven fiber sheet (Lot: TP06112012) was submitted to NAMSA (Irvine, Calif.) for testing utilizing the ASTM E2419 testing protocol with sample size of 1 g, target inoculums level of 1.5-3.0×10⁵ CFU/mL with the organisms Klebsiella pneumonia (KP) source no 4352, Staphylococcus aureus (MRSA) source no 33591, and Enterococcus faecalis (VRE) source no 51575.

Below is the test data, shown in Table 5.

TABLE 5

| | Organism Count | | |
|---|---|---|---|
| Test Article | (CFU/mL) - Zero | | Percent |
| Identification | Time | | Reduction |
| | | Organism Count | |
| | | (CFU/mL) - | |
| | | 4 Hour | |
| TP06112012 - | 3.95 × 10⁵ | 2.23 × 10⁵ | 43.54% |
| MRSA | | | |
| Control - MRSA | 3.50 × 10⁵ | 6.40 × 10⁵ | No reduction |
| | | Organism Count | |
| | | (CFU/mL) - | |
| | | 24 Hour | |
| TP06112012 - KP | 1.38 × 10⁵ | <1.00 × 10¹ | >99.99% |
| TP06112012 - VRE | 3.75 × 10⁵ | <1.00 × 10¹ | >99.99% |
| Control - KP | 1.45 × 10⁵ | >3.00 × 10⁷ | No reduction |
| Control - VRE | 4.55 × 10⁵ | 4.20 × 10⁵ | 7.69% |

### Example 7

### Non-Woven Fiber Material Made with Polypropylene Polymer

This is similar to all above examples with the exception of polypropylene polymer (PP) is substituted for the PLA. The advantage of PP is a higher processing and throughput speed. PP has all the required health and safety and low-bioburden properties. It is also receptive to hydrophilic additives in a masterbatch or surface treatment to impart rapid fluid wet-out. Additives can easily be included in masterbatch form. A PP meltblown web can also be thermally point bonded or placed on a spunbond carrier for additional strength and can be processed in a secondary treatment step to impart a copper and silver-containing treatment.

In this example we used ExxonMobil (Houston, Tex.) Achieve 6936G ultra-high melt flow rate polypropylene at the 100% level and with additives. One distinct advantage was lower melt processing conditions when compared to PLA. Extruder and spinning temperatures in the 275 to 350° F. range were sufficient and this product and this allowed polymer additives that were heat-intolerant to be utilized.

The table below (Table 6) shows the particulars of a 3BSK-1 all PP sample manufactured on the meltblown line. 3BSK-1 consists of two 50 gsm PP melt spun layers and 25 gsm of SAP, calendared to bond the SAP between the two layers of PP.

TABLE 6

| | | | | | Tensile |
|---|---|---|---|---|---|
| | | | | | Strength |
| | Line | | | | (ASTM |
| | Speed | Temperature | Calendar | Thickness | D5035) |
| | (ft/min) | (F.) | Gap (in) | (in) | in/lbs |
| 3BSK-1 | 10 | 250 | 0.005 | 0.019 | 5.65 |
| W/O Edge | | | | | |
| Sealing | | | | | |
| 3BSK-1 W/ | 10 | 250 | 0.005 | 0.019 | 3.951 |
| Edge | | | | | |
| Sealing | | | | | |

Melt spun PP of various densities and thicknesses were calendared at a close nip under high pressure to produce a film structure. See test data below (Tables 7 and 8) to see the various structures created and the performance difference between “calendared” and “uncalendared.”

The 33 gsm melt spun PP was calendared at 210° F., at 10 fpm (feet per minute), at 0.001″ gap, under 1000 psi, to create “PP Film 1”.

TABLE 7

| | Tensile Strength (ASTM | Apparent Elongation |
|---|---|---|
| | D5035), in/lbs | (%) |
| PP Film 1 - | 1.253 | 29.30 |
| Un-Calendared | | |
| PP Film 1 - Calendared | 2.294 | 15.78 |

A 48 gsm melt spun PP was calendared at 250° F., at 10 fpm, at 0.005″ gap, under 1,000 psi, to create “PP Film 2,” see, Table 8.

TABLE 8

| | Tensile Strength (ASTM | Apparent Elongation |
|---|---|---|
| | D5035), in/lbs | (%) |
| PP Film 2 - | 1.788 | 23.398 |
| Un-Calendared | | |
| PP Film 2 - Calendared | 3.789 | 8.475 |

### Example 8

### Active Structure Made with Polycaprolactone Polymer

This is similar to Example 1, above, with the exception that Polycaprolactone (PCL) is added to the PLA in a blend at various levels from 5% to over 70%. PCL is a naturally derived polymer with a very low melt point. When used at low levels, generally 30% and lower, it functions as a plasticizer for the PLA, a brittle polymer, and imparts lubricity and softness to the fibers that functions to reduce breakage. This dramatic improvement was apparent even at a 2% add-on level and increases with concentration. The PLA/PCL blend incorporated masterbatch additives or surface finishes to modify the hydrophilicity and fluid wet-out speed. Silver was also incorporated. The lower processing temperature of the PCL allows the use of low-temp additives but also limits the effective storage and use temperatures of the finished product.

Below, Tables 9 and 10 show the physical property of various PLA/PCL structures that were manufactured with different mechanical properties. For example, PLA/PCL Structure UC-1 was non-calendared 600 gsm 93% PLA with 3% CP-L01 and 3% CT-L01 and 1% PCL run at 400 F, 3 fpm and 1100 psi. Corresponding test data is shown below for various combinations and permutations wherein the speed, pressure and temperature were changed.

TABLE 9

| | Tensile | | |
|---|---|---|---|
| | Strength | Apparent | |
| | (ASTM | elongation | Break Time |
| | D5035), in/lbs | (%) | (sec) |
| PLA/PCL Structure UC1 | 0.732 | 28.996 | 4.375 |
| PLA/PCL Structure UC2 | 0.937 | 14.131 | 2.141 |
| PLA/PCL Structure UC3 | 1.109 | 16.356 | 2.547 |
| PLA/PCL Structure UC4 | 1.837 | 12.024 | 1.843 |
| PLA/PCL Structure UC5 | 1.731 | 21.465 | 3.313 |
| PLA/PCL Structure UC6 | 1.347 | 22.304 | 3.391 |
| PLA/PCL Structure UC7 | 1.840 | 23.915 | 3.609 |
| PLA/PCL Structure UC8 | 1.360 | 10.460 | 1.594 |
| PLA/PCL Structure UC9 | 1.375 | 18.804 | 2.844 |
| PLA/PCL Structure UC10 | 1.767 | 17.139 | 2.734 |
| PLA/PCL Structure UC11 | 1.730 | 25.954 | 4.000 |
| PLA/PCL Structure UC12 | 1.316 | 21.022 | 3.250 |
| PLA/PCL Structure UC13 | 0.797 | 22.914 | 3.469 |
| PLA/PCL Structure UC14 | 1.176 | 15.248 | 2.312 |
| PLA/PCL Structure UC15 | 0.755 | 27.581 | 4.157 |
| PLA/PCL Structure UC16 | 0.851 | 19.247 | 2.906 |
| PLA/PCL Structure UC17 | 1.205 | 20.022 | 3.094 |
| PLA/PCL Structure UC18 | 1.118 | 23.247 | 3.562 |

The mean is 1.277 lbs for tensile strength, 20.046% for apparent elongation and 3.063 sec for break time.

TABLE 10
By calendaring various samples, the following data was obtained:

| | Tensile | | |
|---|---|---|---|
| | Strength | Apparent | |
| | (ASTM | elongation | Break Time |
| | D5035) | (%) | (sec) |
| PLA/PCL Structure 1 | 1.957 | 18.478 | 2.797 |
| PLA/PCL Structure 2 | 1.636 | 15.690 | 2.468 |
| PLA/PCL Structure 3 | 1.702 | 16.475 | 2.500 |
| PLA/PCL Structure 4 | 1.621 | 14.251 | 2.157 |
| PLA/PCL Structure 5 | 1.357 | 12.808 | 1.937 |
| PLA/PCL Structure 6 | 2.032 | 12.911 | 1.953 |
| PLA/PCL Structure 7 | 1.117 | 23.799 | 3.593 |
| PLA/PCL Structure 8 | 1.481 | 10.696 | 1.704 |
| PLA/PCL Structure 9 | 2.268 | 19.359 | 3.000 |
| PLA/PCL Structure 10 | 2.221 | 17.755 | 2.750 |
| PLA/PCL Structure 11 | 2.185 | 22.342 | 3.375 |

The mean is 1.780 lbs for tensile strength, 16.779% for apparent elongation and 2.567 sec for break time

### Example 9

### Apertured Film and/or Structure with “Actives” and Coloration

This is identical to Example 1 through 8 except the apertured non-woven sheet was pigmented to impart color as requested by customers.

In a similar design, one or both of the films was spunbond or SMS layered on the calender bonded surface of the PLA or PP fibers themselves.

### Example 10

### Fiber Diameter Influence on Performance

By varying the thru put rate of the molten polymer and the air used for attenuation, the fiber diameter and degree of polymer orientation within the fiber may be modified. Additionally, the internal diameter of the polymer nozzles, in the die or spinneret plate can be modified. In this example the polymer and thru put rate was held constant while spinneret plates with different diameters were utilized and the effect of fiber diameters was measured. Extruder zone temperatures, die-head temperatures and pressures, collector belt speed and quench air settings were optimized. Diameters ranging from 0.011 to 0.023 were evaluated and resultant changes in fluid management and physical cushioning were observed. An experimental trial matrix and performance data follow in Table 11 and FIG. 3.

TABLE 11

| | | | | |
|---|---|---|---|---|
| Thru put | g/hole/hour | 13.2 | 19.2 | 42.6 |
| Fiber Diameter | μm | 10 | 15 | 20 |
| Nozzle ID | inches | 0.011 | 0.015 | 0.023 |

FIG. 4 shows a magnified photograph of fibers from 0.015 inch nozzle. FIG. 5, FIG. 6 and FIG. 7 show a magnified photograph of 0.015 inch fibers of the PLA insert in a cross-section of the non-woven pad construction with fiber direction being transverse to an exterior surface. FIG. 5 shows the pad insert orientation wherein the top surface is the horizontal surface on the photograph, and the side of the insert is the vertical surface. In FIGS. 6 and 7, the partially vertical surface is the side of the insert, in an even more magnified photograph.

### Example 11

### Substrate Construction Methodology Influence on Air Permeation

For all the examples mentioned above, it is important to note that the method of construction of the dryer insert non-woven sheets, layers (films) and pouches themselves, and in concert with being calendared and assembled with one another has a direct influence on the air permeation value. And hence, this affects the ability of the complete dryer insert to either absorb moisture and/or water and also concurrently to “breathe” so as to not trap any air under it. The tables above shows the different levels of air permeation for the various boot dryer sheets that have been manufactured.

### Example 12

### PLA Outer Pouch Construction Using Heat Sealing

This outer pouch which is part of the non-woven dryer insert structure is constructed with two outer layers of PLA film. The film layers are 66 gsm PLA with a 2% CP-L01 (Polyvel) additive, calendared at 280° F. at 10 fpm. See, FIG. 8. This outer layer of film adds strength and contains any SAP laden inner fill material that would otherwise spill out. The tensile strength of the film is 5.579 in/lbs and is perforated during calendaring with an engraved roll (Sunday roll); the aperture size is “diamond shaped” and is approximately 0.022 inches in diameter. Triton X-100 (Dow) was applied as surfactant to each outside surface of the outer film before edge sealing to impart hydrophilic characteristics to the PLA.

In another embodiment of the invention, each outer layer of the PLA pouch were constructed of two layers of 50 gsm PLA. A power spreader (Christy Machine Co, Freemont, Ohio), at 50% motor rpm, was used to apply 50 gsm of SAP between the two layers. This was then calendared at 240° F. at 30 fpm to bond the two layers together with the SAP in between. This SAP laden outer layer was then cut into the size needed for the product application, and lightly misted with the surfactant. This approach was used to increase the total capacity of the absorbent pad.

All the PLA layers were comprised PLA fibers incorporating a formulation of silver and copper Zeolite grade AC-10D from AgION coupled with silver glass grade WPA from Marubeni/Ishizuka.

See FIG. 9A which shows the cutting of the PLA sheet.

The film layers were edge sealed on a single side using a ¼″ band, impulse foot sealer (American International Electric, Whittier, Calif.) at the “4” dial setting. Two insert layers were placed at the edge of the seal and then the remaining three sides were sealed. In this application the layer material was cut to 10″ by 12″. See FIG. 9B for construction of the outer pouch by folding the sheet in half and seal on two sides to create a 12″ long pouch.

The absorbent capacity of outer layers without the SAP calendared construction is 0.025 g of water completely saturated. Each layer weighs an average of 0.1 g and was then submerged in water for 60 sec. After a drip time of two minutes the pad weighed 0.125 g. The pad was then submerged again for sixty minutes, allowed a three minute drip time and re-weighed. The end result of 0.125 g full saturated.

The absorbent capacity of outer layers with the SAP calendared construction is 0.5 g of water completely saturated. Each pad weighs an average of 0.1 g and was then submerged in water for 60 sec. After a drip time of two minutes the insert weighed 0.6 g. The pad was then submerged again for sixty minutes, allowed a three minute drip time and re-weighed. Up to the point of full absorption (defined as the point of absorption where there is a visual rupture in the layer material), the layer thickness went from 0.068 inches (dry) to 0.25 inches (wet).

### Example 13

### Creation of the PLA Outer Pouch Construction for the Non-Woven Dryer Insert Structure Using Adhesive

The created PLA non-woven fiber sheet can be cut to sheets and sealed on three edges, or one sheet can be folded over and two edges can be sealed. Refer to FIG. 10 for a schematic view of the process. At first the PLA material is cut to size (see FIG. 10A) and then a specific template is cut with scissors or any industrial die cutter or equivalent arrangement can be utilized (see FIG. 10B). The tabs created by the die cut (see FIG. 10C) are then folded (see FIG. 10D) and then glued to each other such as 3M Super 77 all purpose adhesive (see FIG. 10E). This dryer insert structure functions as the outer pouch, or outer layer of the dryer insert product.

### Example 14

### Creation of SAP in Fibrous Active Structure without Adhesive in PLA Dryer Insert

In this example, superabsorbent polymer (SAP) was added (crosslinked polyacrylic acid grade Favor®Pac 530 and LiquiBloc® 2G-110 from Emerging Technologies (Greensboro, N.C.) as an additive. The SAP was granular and was dispensed uniformly via a powder spreader produced by Christy Machine Co. (Fremont, Ohio). The granules were dispersed directly into the fiber stream or simply onto and between layers of fibers that have already been formed. The fibers can be cut with a slitter or scissors or randomly ripped into small pieces. In the event the SAP was dispersed onto the layer of fiber, the SAP was further ground into the fiber by mixing the combination with a rod or paddle. An industrial mixer can also be utilized if so desired. See FIG. 11 for a photograph of the “SAP fill material”.

It can be advantageous to utilize a pressure sensitive adhesive to construct a more robust structure and contain the SAP to prevent particles from dislodging and reducing the performance of the dryer insert. Those knowledgeable in the art can create the fibrous active structure using adhesive by utilizing a system to spray adhesive on the fibers and then introducing the SAP to the fibers utilizing the powder spreader or by other means. Many adhesives can be used.

Note that other absorbents can be used also including starch-based superabsorbents as offered by ADM (Decatur, Ill.; formerly Lysac), under several brand names and chemical configurations. An advantage of this brand is that is it made from a 100% natural raw material source which is synergistic with the natural polymers used to form fibers and structures of the present invention.

Note that sodium bicarbonate (also known as sodium hydrogen carbonate), NaCHO₃ can be added to the SAP in order to yield additional odor control characteristics. In one embodiment of the invention, the shredded PLA with the SAP was mixed with the sodium bicarbonate at a ratio of 7:1 (8 oz of fill material will have 7 oz of SAP and 1 oz of shredded PLA).

### Example 15

### Inclusion of SAP in Fibrous Active Structure to PLA Dryer Insert Pouch

The SAP laden fibrous material was inserted into the PLA dryer insert pouch by simply using hands (or machine) to place and stuff the fibrous material; see FIG. 12. A mechanical or industrial semi or fully automated insertion methodology similar to a vertical form-fill machine can also be utilized. Once the SAP fibrous material insertion process is finished the final edge of the exemplary PLA boot dryer insert structure can be heat sealed to yield a fully finished boot dryer insert; see FIG. 13. See FIG. 14 for a cross-sectional representation of the boot dryer insert product.

### Example 16

### Creation of PLA Dryer Inner Pouch

In order to improve the robustness of the dryer insert and to make it more rugged and eliminate the possibility of the SAP laden fiber materials leaking out due to the burst, puncture, tearing, splitting or fraying of the PLA non-woven outer layer, an inner pouch (“sock”) was manufactured.

A PLA inner sock structure was manufactured using the manufacturing methodology described above. Firstly, the web was created as described in the meltblown process above and then secondly, a sock structure was generated by heat sealing the edges. First the PLA material was cut into a 10″×12″ sheet; see FIG. 15. Then, the material was folded in half (see FIG. 16) and sealed two sides (see FIG. 17) using a standard heat sealing bar, such as a ¼″ band, impulse foot sealer (American International Electric, Whittier, Calif.) at the “4” dial setting was used to seal the edges creating a 12″ long pouch.

SAP laden inner fill material can be inserted to this embodiment of the invention as described in the previous example.

An inner sock structure was also manufactured by purchasing off-the-shelf SMS polypropylene material (Green Bay Non-Wovens; Green Bay, Wis.). Many suitable spunbond webs are suitable for use as a inner sock structure in the present invention in view of the teaching provided in the present specification (e.g., PP, PET or PLA polymers with hydrophilic or hydrophobic finishes). For this trial, a 48-gsm and 60-gsm SMS web (spunbond/meltblown/spunbond) from Green Bay Nonwovens (Green Bay, Wis.) was selected. It is very strong and uniform of its lightweight. The method of construction was identical to the method described above for the PLA material.

### Example 17

### Inclusion of PLA Inner Pouch to PLA Outer Pouch Using Heat Sealing

The PLA inner pouch (“sock”) structure was inserted and placed into the PLA outer pouch to create the dryer insert product using heat sealing. After the insertion, the final edge of the PLA dryer insert was heat sealed. See FIGS. 18 A & B for the process of placing the inner sock structure into the dryer pouch and then heat sealing (see FIGS. 19 A & B) using a standard heat sealing bar, such as a ¼″ band, impulse foot sealer (American International Electric, Whittier, Calif.) at the “4” dial setting to seal the edges creating a 12″ long boot dryer insert. See FIG. 20 for a cross-sectional illustration of the boot dryer insert product.

### Example 18

### Inclusion of PLA Inner Pouch to PLA Outer Pouch Using Adhesive Sealing

The PLA inner pouch (“sock”) structure was inserted and placed into the PLA outer pouch to create an exemplary dryer insert using adhesive sealing. After the insertion, the final edge of the PLA boot dryer insert was adhesive sealed. See FIG. 21 for the complete process. At first the inner sock structure is placed into the boot dryer outer pouch (FIG. 21A), the edges of the outer pouch (FIG. 21B) are folded with adhesive such as 3M Supper 77 all purpose adhesive and then adhered to the surfaced of the outer pouch (FIG. 21C) to create the boot dryer insert. A construction of this methodology has product edges that are more flexible, pliable, less sharp and less prone to tearing.

### Example 19

### Creation of a PP Boot Dryer Insert with PP Outer Layer with PLA SAP Fibrous Inner Material

Similar to examples above, a polypropylene boot dryer insert can be constructed by using polypropylene non-woven sheets for the outer layer structure and then inserting into the PP outer layer SAP laden fibrous inner material manufactured from PLA.

Those knowledgeable in the art realize that PP based fibrous inner material laden with SAP can easily be constructed.

### Example 20

### Creation of a PP Boot Dryer Insert with PP Outer Layer with PP Inner Sock Structure

Similar to examples above, a polypropylene boot dryer insert can be constructed by using polypropylene non-woven sheets for the outer layer structure and then inserting a PP inner sock structure that has SAP laden fibrous inner material manufactured from PP.

Those knowledgeable in the art realize that PLA constructed SAP laden fibrous materials or PLA constructed inner sock structure can easily be substituted in the above examples.

### Example 21

### Boot Dryer Insert Performance Testing—1

A calendared 120 gsm PLA non-woven (60% PLA and 40% HD-L02 from Polyvel) is calendared at 210 degrees F. at 20 fpm to yield the outer pouch material. For this example, this outer material was cut into 6″×8″ pieces. Upon folding the piece in half towards the 6″ sides and then sealed at #6 setting using a standard heat sealing bar, such as a ¼″ band, impulse foot sealer (American International Electric, Whittier, Calif.), a cylinder 6″ length and approximately 3″ in diameter is manufactured for the outer pouch.

For SAP laden PLA fill material, the PLA was cut or shredded into small pieces, less than 1″×1″ and combined with the SAP as exemplified above. The shredded PLA with the LiquiBloc® 2G-110 from Emerging Technologies (Greensboro, N.C.) SAP at a 5:1 ratio. For every one ounce of shredded PLA five ounces of SAP were used.

Upon sealing one of the 4″ ends and filling the material with 1.9 ounces of the SAP laden PLA fill material mixture. Then the final side was sealed to yield the complete boot dryer insert. The total weight of the boot dryer insert is 2 oz.

An Army issued Vibram brand, 5-07, size 10 W, tan, dessert issue combat boot was used in our testing. The boot weight was 2.0 lbs or 0.9 kg completely dry for each boot. The boots were submerged in a bucket of water for about an hour. Total wet weight was 2.5 lbs. or 1.14 kg completely saturated with water. After a drip time of an hour to four hours the boots each weighed 1.06 to 1.08 kg (2.33 to 2.38 lbs). Our objective was to dry a wet boot within 8 hrs. The soaked boots were allowed to drip dry for about five minutes. After the drip dry, one or more boot dryer inserts were placed in each boot, as indicated below. A time-clock was used to measure the time interval when the inside and outside of the boots were dry to touch. The boot dryer inserts were taken out and placed in ambient environment for 6 hours for drying (low temperature oven heat is also suitable for drying the inert). Then they were re-inserted back into the wet boots (condition initiated in the same fashion as before) and the process was repeated. The process was repeated up to the point when the inside and the outside of the boots were not dry to the touch.

The boot dryer insert dimensions were 5″ length and 3″ diameter. Six of the boot dryer insert products were used for each boot; various size boots will require different quantities.

The boot dryer inserts can be used multiple times depending on the wetness of the boot. We designed the boot dryer insert to be used five times for a completely saturated boot, allowing the boot dryer insert to air dry between iterations. The boot dryer inserts can be used more than five times but drying time increases after each use beyond the fifth iteration.

For differing levels of temperature and humidity, an environmental chamber (Forma-Scientific Steri-Cult 200 incubator, model#3033) was used.

Boot dryer insert data is presented in Table 12, below.

TABLE 12

| Temperature & Humidity | Drying Time | Number of Uses |
|---|---|---|
| 60 degrees @ 40% | 6 hrs | 7 |
| 70 degrees @ 50% | 6 hrs | 7 |
| 90 degrees @ 99% | 14 hrs | 5 |
| 40 degrees @ 99% | 14 hrs | 5 |

Number of uses equals the number of times the insert was used in successive boot drying tests.

### Example 22

### Boot Dryer Insert Performance Testing—2

The 180 gsm nonwoven PLA with 40% HD-L02 (Polyvel, Hammonton, N.J.), calendared at 210 degrees F. at 20 fpm, with a moisture vapor transmission rate of 77.06 grams an hour per square meter and hydrophobic due to treatment with a PS9725 surfactant from Goulston (Monroe, N.C.), at 0.01% dilution in water, with an MVTR (permeation) of 79.6 gh/m² was used to create the outer pouch in similar fashion as exemplified above.

60 gsm SMS (Green Bay Nonwoven, Green Bay, Wis.) with a moisture vapor transmission rate of 75.49 grams an hour per square meter was used to create the inner pouch in similar fashion as exemplified above.

Shredded PLA non-woven material was combined with SAP with a 7:1 ratio (seven parts SAP to one part shredded PLA), to create the inner fill material, in similar fashion as exemplified above.

The fill material was placed within an inner pouch, which in turn was placed in the outer pouch to yield a finished boot insert dryer product, similar in fashion to the example exemplified above. This mixture increases flexibility and longevity of the boot dryer inserts, as well as decreases the net weight of the product itself.

Identical test conditions were utilized as in Example 21, with two key exceptions:

i. The size of the boot dryer insert is 3 in×12 in.
ii. There are two boot dryer inserts per boot in the orientation as shown in FIG. 22A-C and FIG. 23.

Boot dryer insert data is presented in Table 13, below.

TABLE 13

| Temperature & Humidity | Drying Time | Number of Uses |
|---|---|---|
| 60 degrees @ 40% | 6 hrs | 7 |
| 70 degrees @ 50% | 6 hrs | 7 |
| 90 degrees @ 99% | 14 hrs | 5 |
| 40 degrees @ 99% | 14 hrs | 5 |

### Example 23

### Boot Dryer Insert Performance Testing—3

Boot dryer inner pouch variations were also created to absorb foot odor, and equal amounts of sodium bicarbonate (NaCHO₃) and SAP were mixed prior to the 7:1 ratio mixing for the PLA fill material. All other methods of manufacturing and the specifications of the materials for the creation of the boot dryer insert are identical to Example 21. Initial testing showed no decrease in water absorption or increase in drying time when tested for 1 or 2 wet-dry cycle times.

Placement of the various boot dryer insert products inside the boot are shown in FIG. 22A-C.

The data is shown in Tables 14A-C.

TABLE 14A

| Boot | | Total Weight |
|---|---|---|
| Dryer # | Description | (lbs) |
| B1 & B2 | 12″ Length w/ 10″ × 12″ Inner Pouch, 8 oz of 3:1 Fill Material | 1.05 |
| D1 & D2 | 12″ Length w/ 10″ × 12″ Inner Pouch, 8.5 oz of 7:1 Fill Material | 1.15 |
| E1 & E2 | 10″ Length w/ 10″ × 10″ Inner Pouch, ½ SAP& ½ NaCHO₃, 8 oz of 7:1 | 1.05 |
| F1 & F2 | 12″ Length w/ 12″ × 12″ Inner Pouch, ½ SAP& ½ NaCHO₃, 8 oz of 7:1 | 1.05 |
| G1 & G2 | 12″ Length w/ 10″ × 12″ Inner Pouch, 13 oz SAP (3/4 full) | 1.65 |
| H1 & H2 | 10″ Length w/ 4ea-4″ Pouches, 2.5 to 2.8 oz SAP | 1.45 |
| I1 & I2 | 10″ Length Treated with Surfactant w/ “E” Inner Pouch Specs | 1.05 |

TABLE 14B

| | Boot # | | | | | |
|---|---|---|---|---|---|---|
| | 1C | 2C | 1D | 2D | 1E | 2E |
| Dry Weight | 2.05 | 2.05 | 2.05 | 2.05 | 2.10 | 2.15 |
| Wet Weight | 2.55 | 2.55 | 2.55 | 2.55 | 2.65 | 2.65 |
| Boot Dryer Bottom # | B1 | D1 | E1 | F1 | G1 | N/A |
| & Weight | 0.65 | 0.70 | 0.55 | 0.55 | 0.90 | |
| Boot DryerTop # & | B2 | D2 | E2 | F2 | G2 | N/A |
| Weight | 0.55 | 0.65 | 0.55 | 0.50 | 0.85 | |
| After 6 hr Dry Time | | | | | | |
| Boot Weight | 2.30 | 2.30 | 2.30 | 2.30 | 2.35 | 2.50 |
| Boot Dryer Bottom | 0.80 | 0.85 | 0.65 | 0.65 | 1.00 | N/A |
| Weight | | | | | | |
| Boot DryerTop | 0.55 | 0.65 | 0.55 | 0.55 | 0.85 | N/A |
| Weight | | | | | | |
| Water Loss | 0.25 | 0.25 | 0.25 | 0.25 | 0.30 | 0.15 |
| Water Remaining | 0.25 | 0.25 | 0.25 | 0.25 | 0.25 | 0.35 |
| After 22 hrs Dry Time | | | | | | |
| No Boot Dryers | | | | | | |
| Boot Weight | 2.15 | 2.15 | 2.15 | 2.15 | 2.20 | 2.30 |
| Water Loss | 0.15 | 0.15 | 0.15 | 0.15 | 0.15 | 0.20 |
| Water Remaining | 0.10 | 0.10 | 0.10 | 0.10 | 0.10 | 0.15 |

*All weights are accurate within +/−0.05 lbs. Boot Dryers B and D were on their 2^{nd} use, Boot Dryers E thru G were on their 1^{st} use.

TABLE 14C

| | Boot # | | | | | | | |
|---|---|---|---|---|---|---|---|---|
| | 2E | 1E | 2D | 1D | 2C | 1C | 1B | 2B |
| Dry Weight | 2.15 | 2.10 | 2.05 | 2.05 | 2.05 | 2.05 | 2.20 | 2.20 |
| Wet Weight | 2.65 | 2.60 | 2.55 | 2.55 | 2.55 | 2.55 | 2.80 | 2.80 |
| Boot Dryer | B1 | D1 | E1 | F1 | G1 | H1 | I1 | N/A |
| Bottom # | 0.65 | 0.70 | 0.55 | 0.55 | 0.90 | 0.70 | 0.50 | |
| & Weight | | | | | | | | |
| Boot Dryer | B2 | D2 | E2 | F2 | G2 | H2 | I2 | N/A |
| Top # & | 0.55 | 0.65 | 0.55 | 0.50 | 0.85 | 0.75 | 0.50 | |
| Weight | | | | | | | | |
| After 8 hr | | | | | | | | |
| Dry Time | | | | | | | | |
| Boot Weight | 2.30 | 2.30 | 2.25 | 2.25 | 2.25 | 2.25 | 2.45 | 2.55 |
| Boot Dryer | B1 | D1 | E1 | F1 | G1 | H1 | I1 | N/A |
| Bottom | 0.70 | 0.80 | 0.65 | 0.65 | 1.00 | 0.80 | 0.60 | |
| Weight | | | | | | | | |
| Boot Dryer | B2 | D2 | E2 | F2 | G2 | H2 | I2 | N/A |
| Top | 0.55 | 0.65 | 0.55 | 0.60 | 0.90 | 0.75 | 0.60 | |
| Weight | | | | | | | | |
| Boot Dryer | 0.10 | 0.10 | 0.15 | 0.25 | 0.20 | 0.15 | 0.15 | N/A |
| Water Weight | | | | | | | | |
| Gain | | | | | | | | |
| Water Loss | 0.35 | 0.30 | 0.30 | 0.30 | 0.30 | 0.30 | 0.30 | 0.25 |
| Estimated | 0.25 | 0.20 | 0.15 | 0.05 | 0.10 | 0.15 | 0.15 | 0.25 |
| Water | | | | | | | | |
| Evaporation | | | | | | | | |
| Water | 0.10 | 0.15 | 0.15 | 0.15 | 0.15 | 0.15 | 0.20 | 0.35 |
| Remaining | | | | | | | | |

*All weights are accurate within +/−0.05 lbs. Boot Dryers B and D are on their 3^{rd} use, Boot Dryers E thru G are on their 2^{nd} use, and Boot Dryers H and I are on their 1^{st} use.

With every test the control boot, without boot dryer inserts, was wet to the touch. Each test boot, with the boot dryers, had residual water weight but felt dry to the touch, with the exception of the toe area, where the orientation of the boot dryer did not reach the toe area (boot dryers G&H). Boot dryers I1&I2 with the outer layer treated with surfactant did not absorb more water in the same time. Ratio of SAP in fill material only slightly changes the water absorption ability. The major factor is the orientation of the boot dryers inside of the boot. The boot dryers F1&F2 were more flexible and were oriented so the top boot dryer fit under the end of the bottom boot dryer. All other boot dryer orientation was next to or on top of the other as shown in FIG. 22A-C.

### Example 23

### Other Boot Dryer Designs

If the inner pouch was made with 100% SAP the flexibility of the boot dryer insert decreased and did not fit into the boot well, decreasing the absorption. Total weight of the boot dryer inserts increase with increasing ratios of SAP in the inner pouch although this does not present a use problem. There are many other approaches for that one of ordinary skill in the art can make with the guidance provided by the present specification with regard to, for example, shape, size, absorbance, etc. One such exemplification is shown in FIG. 24.

What is claimed is:

1. An absorbent, biodegradable dryer insert, comprising: an outer pouch and an inner core, said inner core comprising at least one layer of non-woven fibers comprising one or more biodegradable thermoplastic polymers and one or more silver-based or silver ion-based antimicrobial and one or more copper-based or copper-ion based antifungal agents and one or more sodium chlorate based odor control agents.

2. The dryer insert of claim 1, suitable for drying wearable items selected from a group consisting of footwear, gloves, hats, underwear and clothing.

3. The dryer insert of claim 1, wherein the fibers are oriented to provide compression resistance and maintain paths for liquid-flow and air-flow, said fibers oriented substantially in a direction transverse to an exterior surface.

4. The dryer insert of claim 1, wherein said dryer inner core also comprises one or more superabsorbent polymers.

5. The dryer insert of claim 4, wherein said dryer inner core is placed in an inner pouch.

6. The dryer insert of claim 5, wherein inner pouch is inserted in the outer pouch.

7. The dryer insert of claim 1, wherein said silver-based antimicrobial agents are selected from one or more of a group consisting of silver halides, nitrates, nitrites, selenites, selenides, sulphites, sulphates, sulphadiazine, silver polysaccharides, silver zirconium complexes, or mixtures thereof.

8. The dryer insert of claim 1, wherein said silver ion-based antimicrobial are selected from one or more of a group consisting of Ag-ion, zeolite-Ag, glass-Ag and nano-silver.

9. The dryer insert of claim 1, wherein said copper ion-based antifungal are selected from one of more of a group consisting of Cu-ion, zeolite-Cu.

10. The dryer insert of claim 1, wherein said odor control agent comprises sodium bicarbonate.

11. The dryer insert of claim 1, wherein said non-woven fibers comprise one or more of polylactic acid, polylactide, polyglycolide, poly-L-lactide, poly-DL-lactide.

12. The dryer insert of claim 6, wherein said biodegradable thermoplastic polymers comprise polylactic acid (PLA).

13. The dryer insert of claim 1, wherein said the outer pouch of the dryer insert also comprises a surface film.

14. The dryer insert of claim 13, wherein said surface film that is hydrophobic or hydrophilic.

15. The dryer insert of claim 13, wherein the outer layer of the surface film is created by calendaring non-woven material.

16. The dryer insert of claim 13, wherein said surface film comprises apertures.

17. The dryer insert of claim 13, wherein said surface film does not comprise apertures.

18. The dryer insert of claim 13, wherein said surface comprises one or more of cellulose, alginate, gums, starch, chitosan, ethylene glycol, poly-oxethylene, and polylactic acid.

19. The dryer insert of claim 1, wherein said non-woven fiber material comprises one or more of polylactic acid, polylactide, polyglycolide, poly-L-lactide, poly-DL-lactide or copolymers thereof.

20. The dryer insert of claim 1, where said outer pouch surface film comprises one or more of polypropylene, polyurethane, polyethylene and other petroleum based polymers.

21. The dryer insert of claim 1, where said inner layer fill material is a thermoplastic polymer hydrophilic or hydrophobic film comprising of polypropylene, polyurethane, polyethylene and other petroleum based polymers.

22. The dryer insert of claim 5, where said inner pouch material is comprises of one of more of polypropylene, polyurethane, polyethylene and other petroleum based polymers.

23. The dryer insert of claim 13, wherein the outer layer surface film and the core are calendared together.

24. The dryer insert of claim 13, wherein the outer layer surface film layer and the inner pouch core are sealed together.

25. The dryer insert of claim 1, wherein said fibers are vertically lapped or spirally wound.

26. The dryer insert of claim 1, wherein said one or more antimicrobial agents are released upon contact of moisture with the thermoplastic polymer fibers.

27. The dryer insert of claim 13, wherein the outer layer surface film and inner core pouch are concentric to each other in multiplicities.

28. The dryer insert of claim 4, wherein the superabsorbent polymer is embedded into the fibrous material core.

29. The dryer insert of claim 4, wherein the superabsorbent polymer is adhered to fibrous material core.

30. The dryer insert of claim 13, wherein the outer layer surface film comprises a top film and a bottom film and the top and bottom film are sealed along the edges.
